(19) United States
(12) Patent Application Publication
(10) Pub. No.: US 2013/0004726 A1
(43) Pub. Date: Jan. 3, 2013

(54) Light Guide Plate, and Method and Apparatus of Manufacturing Same

(76) Inventors: Doo Jin Park, Yongin-si (KR); Ji Hwan Park, Yongin-si (KR)

(21) Appl. No.: 13/583,855

(22) PCT Filed: Jan. 18, 2011
(86) PCT No.: PCT/KR2011/000353

§ 371 Date: Sep. 10, 2012

(30) Foreign Application Priority Data
Dec. 2, 2010 (KR) 10-2010-0122116

(51) Int. Cl. B32B 3/30; B29C 35/08; C08J 7/04

(52) U.S. Cl. 428/172; 427/510; 425/174.4

(57) ABSTRACT

The present invention relates to a light guide plate, and a method and apparatus of manufacturing the same. The light guide plate includes; a transparent substrate including an active area and a dummy area defined in the periphery of the active area, wherein a groove for coupling other members is defined in the dummy area; and a pattern layer disposed on one surface of the substrate. The pattern layer is not disposed on the dummy area of the substrate, but disposed on the active area of the substrate. Since the pattern layer is formed on only the active are of the substrate using a spinless process, a material for forming the pattern layer may not be wasted to reduce material costs. Also, since a plurality of grooves are formed in the substrate before the pattern layer is formed on the substrate, conventional limitations, whereby it is difficult to perform a groove forming process due to a pattern layer cured by forming a plurality of grooves after the pattern layer is formed, may be overcome.

### TECHNICAL FIELD

The present invention relates to a light guide plate capable of being applied to a backlight of a liquid crystal display (LCD) device.

### Background Art

Generally, liquid crystal display (LCD) device does not have a light source in itself. Thus, a backlight unit functioning as a light source is mounted on the rear of a liquid crystal panel. The backlight unit functioning as the light source of the LCD device may be largely classified into a direct type and an edge type.

In case of the direct type, a light source is arranged on an entire lower surface of the liquid crystal panel, whereby light emitted from the light source is directly transmitted to the liquid crystal panel. Meanwhile, in case of the edge type, a light source is arranged at one lower side of the liquid crystal panel, whereby light emitted from the light source is transmitted to the liquid crystal panel through the use of light guide plate.

Hereinafter, an edge type LCD device according to the related art will be described with reference to the accompanying drawings.

FIG. 1 is a cross sectional view of an LCD device according to the related art, and FIGS. 2a and 2b are plane view and cross sectional view of a light guide plate according to the related art.

As shown in FIG. 1, the LCD device according to the related art includes a liquid crystal panel 1 and a backlight unit 2.

The liquid crystal panel 1 is formed in such a way that a liquid crystal layer is provided between lower and upper substrates.

The backlight unit 2 is positioned below the liquid crystal panel 1, and the backlight unit 2 emits light to the liquid crystal panel 1.

The backlight unit 2 includes a light guide plate 10, a light source 20, optical sheets 30, and a reflection plate 40.

The light guide plate 10 guides the light emitted from the light source 20 toward the liquid crystal panel 1.

The light source 20 is positioned at a lateral side of the light guide plate 10, and the light source 20 emits light to the lateral side of the light guide plate 10.

The optical sheets 30 uniformly transmit the light passing through the light guide plate 10 to the liquid crystal panel 1, wherein the optical sheets 30 are formed by combining a plurality of sheets such as diffusion sheet and prism sheet.

The reflection plate 40 is positioned below the light guide plate 10, to thereby prevent a loss of light emitted from the light source.

As shown in FIGS. 2a and 2b, the light guide plate 10 according to the related art comprises a predetermined pattern layer 14 on a substrate 12 so as to change a path of light.

At the edges of the light guide plate 40, there are a plurality of grooves 15 to be combined with other members. That is, the light guide plate 10 is combined with other members through the grooves 15, to thereby complete the backlight unit.

The light guide plate 10 according to the related art may be manufactured by steps of coating a predetermined material on the entire surface of the substrate 12 through a spin coating method; forming the pattern layer 14 through the use of predetermined mold; and forming the grooves 15 by removing predetermined portions at the side.

However, in case of the light guide plate 10 according to the related art, the grooves 15 are formed after forming the pattern layer 15 on the substrate 12. For forming the grooves 15, the pattern layer 14 is removed together with the substrate 12. However, since hardness of the pattern layer 14 becomes strong after completing the curing process, it is difficult to carry out the process of forming the grooves 15, which might cause the increase of defect.

In the light guide plate 10 according to the related art, since the predetermined material is coated on the entire surface of the substrate 12 through the spin coating method, the pattern layer 14 is coated on the entire surface of the substrate 12. However, light travel is interrupted in the edges of the light guide plate 10 because the grooves 15 of the edge of the light guide plate 10 are combined with other members. That is, if the material is coated on the entire surface of the substrate 12, the material is wasted. Also, a large amount of material is wasted during the spin coating process, which causes the increase of material cost.

### DISCLOSURE

### Technical Problem

Therefore, the present invention has been made in view of the above problems, and it is an object of the present invention to provide a light guide plate which overcomes a problem of defects during a process of forming grooves, and reduces a material cost by preventing a material from being wasted.

### Technical Solution

To achieve these objects and other advantages and in accordance with the purpose of the invention, as embodied and broadly described herein, there is provided a light guide plate comprising: a transparent substrate including active and dummy areas, wherein the dummy area is positioned in the circumference of the active area, and the dummy area is provided with a plurality of grooves to be combined with other members; and a pattern layer on one surface of the substrate, wherein the pattern layer is formed in the active area of the substrate, and is not formed in the dummy area of the substrate.

Also, the substrate and pattern layer are formed of poly methyl methacrylate (PMMA), and an adhesive is not provided between the substrate and pattern layer.

Furthermore, bead structure are additionally included in the pattern layer.

Also, a pattern layer is additionally formed on the other surface of the substrate, and the pattern layer on the other surface of the substrate is not formed in the dummy area, and is formed in the active area.

In another aspect of the present invention, there is provided a method of manufacturing a light guide plate with a pattern layer on an active area of a substrate comprising: preparing the substrate with a plurality of grooves in a dummy area in the circumference of the active area; coating the active area of the substrate with a pattern material by a spinless coating method; curing edges of the pattern material coated; forming a pattern in the pattern material by bring a predetermined mold into contact with the pattern material; curing the pattern material while being brought into contact with the mold; and separating the mold.

In addition, the method further comprises carrying out IR (infrared ray) or UV (ultraviolet ray) drying process and cooling process after coating the pattern material.

The process of coating the pattern material comprises coating the pattern material including bead structures therein.

Also, the processes of forming the pattern in the pattern material, curing the pattern material, and separating the mold are consecutively carried out by an apparatus including a pair of first rolls consisting of a first upper roll and a first lower roll, a pair of second rolls consisting of a second upper roll and a second lower roll, a mold wound on the first upper roll and the second upper roll, and a UV irradiation apparatus positioned between the first upper roll and the second upper roll.

In another aspect of the present invention, there is provided an apparatus of manufacturing a light guide plate comprising: a pair of first roll consisting of a first upper roll and a first lower roll; a pair of second roll consisting of a second upper roll and a second lower roll; a third roll positioned in the rear upper side of the second upper roll; a fourth roll positioned in the upper side between the first upper roll and the second upper roll; a mold rotated while being wound among the first upper roll, the second upper roll, the third roll and the fourth roll; and a UV irradiation apparatus positioned between the first upper roll and the second upper roll.

### Advantageous Effects

According to the present invention, a material for forming the pattern layer is not wasted because the pattern layer is formed only in the active area of the substrate through a spinless coating process. Also, a plurality of grooves are formed before forming the pattern layer on the substrate, so that it is possible to overcome a related art problem of defects, wherein the defects are caused by difficulties in forming the grooves when the plurality of grooves are formed in the cured pattern layer after curing the pattern layer.

### DESCRIPTION OF DRAWINGS

FIG. 1 is a cross sectional view of an LCD device according to the related art.

FIGS. 2a and 2b are plane view and cross sectional view of a light guide plate according to the related art.

FIG. 3a is a plane view of a light guide plate according to one embodiment of the present invention, and FIG. 3b is a cross sectional view of a light guide plate according to one embodiment of the present invention.

FIG. 4 is a cross sectional view of a light guide plate according to another embodiment of the present invention.

FIG. 5 is a cross sectional view of a light guide plate according to another embodiment of the present invention.

FIGS. 6a to 6f are cross sectional views of a method of manufacturing a light guide plate according to one embodiment of the present invention.

FIG. 7 is a rough view of an apparatus of manufacturing a light guide plate according to one embodiment of the present invention.

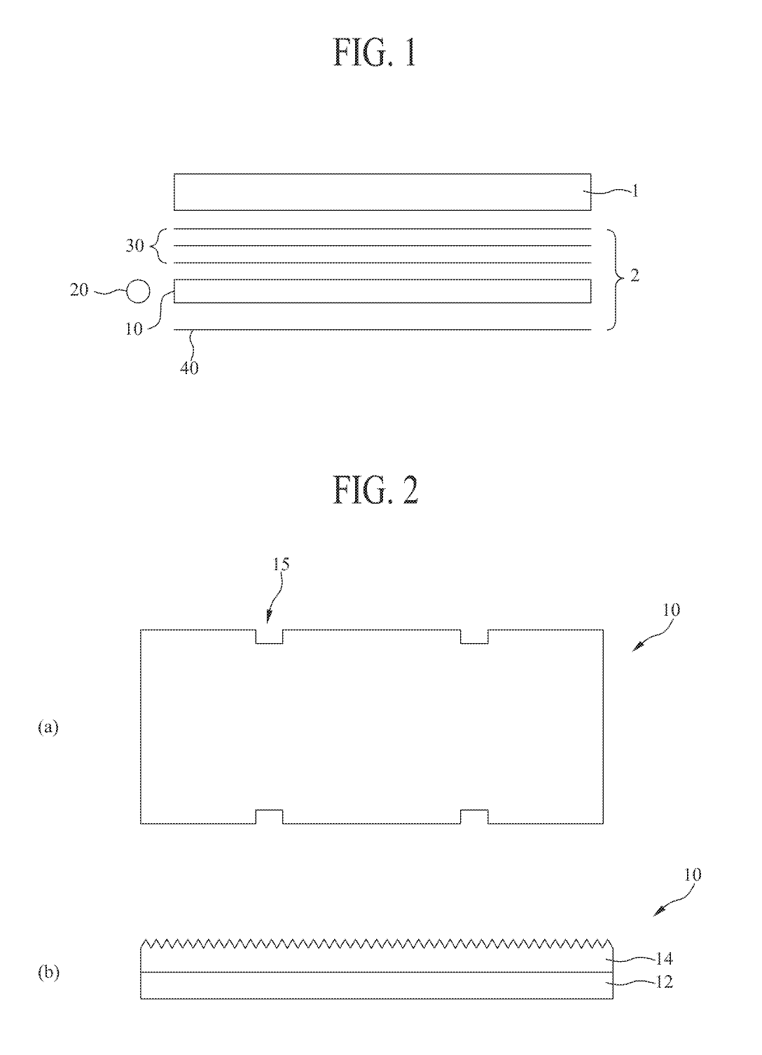

### DETAILED DESCRIPTION

Reference will now be made in detail to the preferred embodiments of the present invention, examples of which are illustrated in the accompanying drawings.

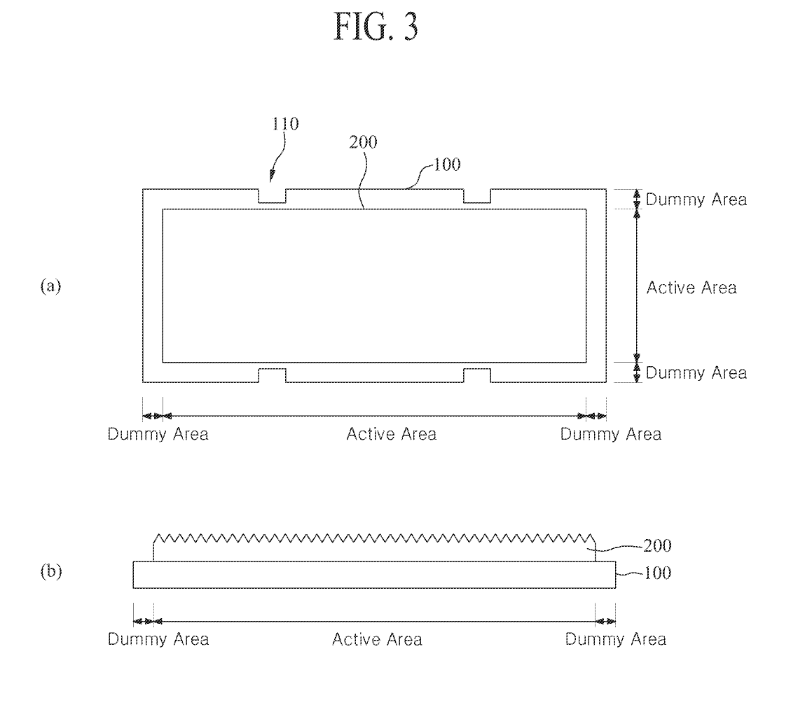

FIG. 3a is a plane view of a light guide plate according to one embodiment of the present invention, and FIG. 3b is a cross sectional view of a light guide plate according to one embodiment of the present invention.

As shown in FIGS. 3a and 3b, a light guide plate according to one embodiment of the present invention includes a substrate 100 and a pattern layer 200.

The substrate 100 is formed of a transparent material, for example, poly methyl methacrylate (PMMA). Owing to great transmittance of PMMA, PMMA is appropriate for a material of light guide plate. However, the material of substrate 100 is not limited to PMMA.

The substrate 100 is a base of the light guide plate, wherein the substrate 100 includes an active area and a dummy area. In the active area positioned in the center of the substrate 100, light travels toward a liquid crystal panel. In the dummy area positioned in the circumference of the substrate 100, light doesn't travel toward the light crystal panel. The dummy area corresponds to a peripheral region of the active area.

The dummy area of the substrate 100 is provided with a plurality of grooves 110. By the use of grooves 100, the light guide plate may be combined with other members of a backlight unit.

The pattern layer 200 is formed on a surface of the substrate 100. Especially, the pattern layer 200 is formed in the active area of the substrate 100, and is not formed in the dummy area of the substrate 100.

Through a spinless coating process instead of a spin coating process, the pattern layer 200 is formed in the active area of the substrate 100. According to the present invention, it is possible to prevent a material for forming the pattern layer 200 from being wasted, to thereby reduce a material cost.

The pattern layer 200 may have an uneven surface structure, wherein a cross sectional shape of the uneven surface structure may vary, for example, triangular cross section, circular cross section, elliptical cross section, and etc. On the plane view, the uneven surface with the above cross section may be a stripe pattern, matrix pattern, or dot pattern.

By applying the various shapes of pattern layer 200, it is possible to reduce the number of optical sheets to be used, or not to use the optical sheets such as prism sheets.

The pattern layer 200 may be formed of poly methyl poly methyl methacrylate (PMMA). In this case, poly methyl methacrylate (PMMA) may be obtained by curing methyl methacrylate (MMA). Thus, without using an additional adhesive, the pattern layer 200 of poly methyl methacrylate (PMMA) may be formed on the substrate 100. That is, it is possible that the adhesive is not provided between the substrate 100 and the pattern layer 200. This will be easily understood with reference to the following processes.

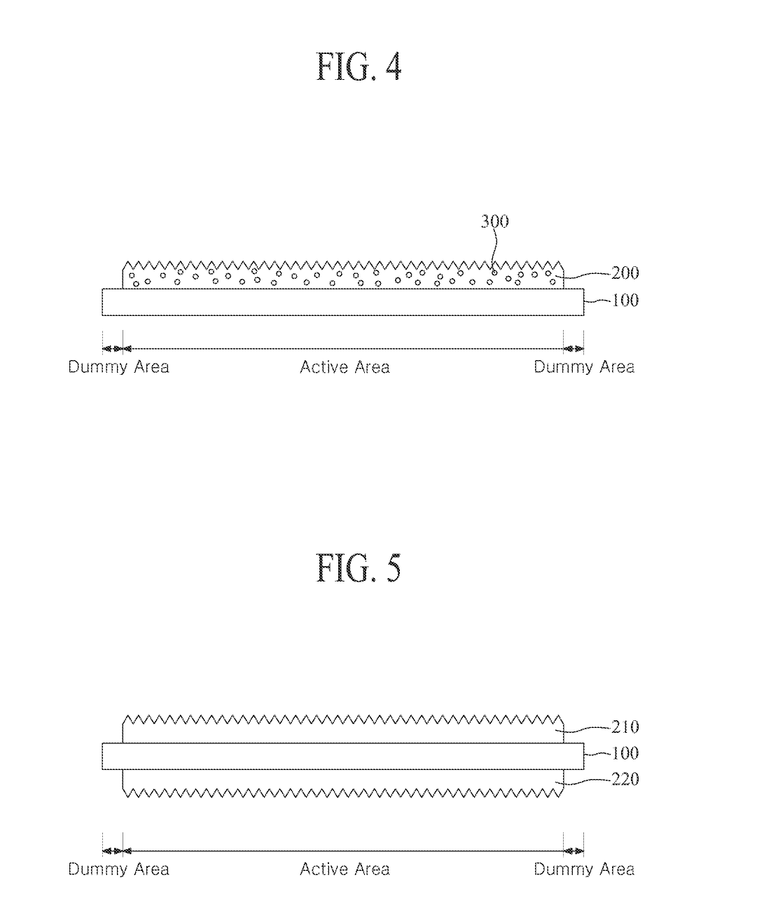

FIG. 4 is a cross sectional view of a light guide plate according to another embodiment of the present invention. Except that bead structures 300 are included in a pattern layer 200, the light guide plate of FIG. 4 is identical in structure to the light guide plate of FIGS. 3a and 3b. Thus, wherever possible, the same reference numbers will be used throughout the drawings to refer to the same or like parts, and a detailed explanation for the same parts will be omitted.

As shown in FIG. 4, the light guide plate according to another embodiment of the present invention includes a substrate 100, the pattern layer 200 on an active area of the substrate 100, and the bead structures 300 included in the pattern layer 200.

The bead structures 300 are provided to enhance light efficiency by diffusing light. If additionally providing the bead structures 300, it is possible to enhance the light efficiency of light guide plate.

The bead structures 300 may be formed of oxide, for example, SnO₂, TiO₂, ZnO₂, SiO₂, CeO₂, and etc.

FIG. 5 is a cross sectional view of a light guide plate according to another embodiment of the present invention. Except that pattern layers 210 and 220 are formed on both surfaces of a substrate 100, the light guide plate of FIG. 5 is identical in structure to the light guide plate of FIGS. 3a and 3b. Thus, wherever possible, the same reference numbers will be used throughout the drawings to refer to the same or like parts, and a detailed explanation for the same parts will be omitted.

As shown in FIG. 5, the light guide plate according to another embodiment of the present invention includes the substrate 100, the first pattern layer 210 on an active area of one surface of the substrate 100, and the second pattern layer 220 on an active area of the other surface of the substrate 100.

A detailed structure of each of the first and second pattern layers 210 and 220 is the same as that of the pattern layer 200 shown in FIGS. 3a and 3b.

Meanwhile, bead structures may be included in at least any one of the first and second pattern layers 210 and 220.

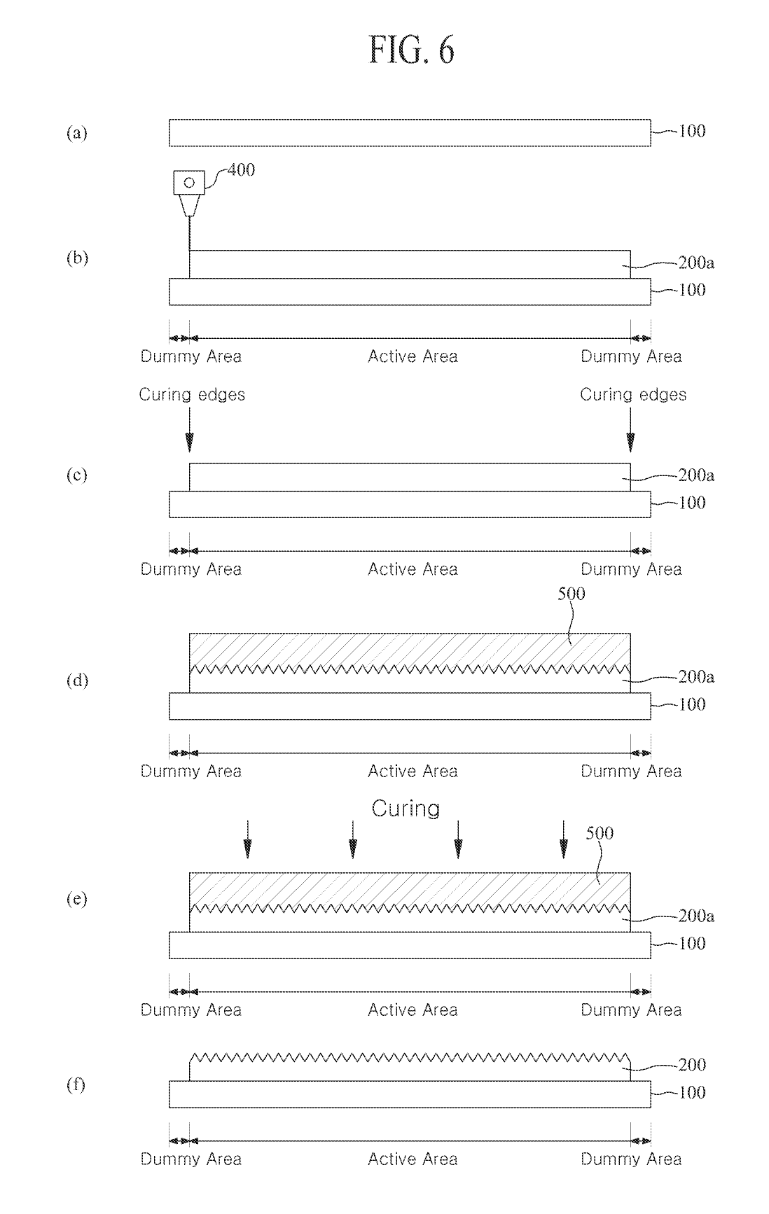

FIGS. 6a to 6f are cross sectional views of a method of manufacturing the light guide plate according to one embodiment of the present invention, in particular, the light guide plate according to FIGS. 3a and 3b.

First, as shown in FIG. 6a, the substrate 100 is prepared.

The substrate 100 may be formed of poly methyl methacrylate (PMMA), but not necessarily.

A process of preparing the substrate 100 includes a step of forming the plurality of grooves in the dummy area corresponding to the peripheral region of the active area of the substrate 100. The step of forming the plurality of grooves may be carried in various methods generally known to those in the art.

Before forming the pattern layer on the substrate 100, the plurality of grooves are formed in the substrate 100. Thus, it is possible to overcome a related art problem related with difficulty in the step of forming the plurality of grooves, wherein the related art problem occurs when the pattern layer is cured and then the plurality of grooves are formed in the cured pattern layer.

If needed, it is possible to manufacture the substrate 100 with the plurality of grooves in the manufacturing process, instead of forming the plurality of grooves in the manufactured substrate 100 after manufacturing the substrate 100.

As shown in FIG. 6b, a pattern material 200a is coated on the active area of the substrate 100.

The pattern material 200a may be formed of methyl methacrylate (MMA). Because methyl methacrylate (MMA) is a low molecule of liquid state, methyl methacrylate (MMA) may be coated on the active area of the substrate 100 by the spinless coating process using a printing nozzle 400.

For the spinless coating process, the printing nozzle 400 is moved while the substrate 100 is fixed, or the substrate 100 is moved while the printing nozzle 400 is fixed.

If needed, an additive such as polymerization initiator or curing agent may be added into methyl methacrylate (MMA), and then methyl methacrylate (MMA) with the additive therein may be coated.

Although not shown, after coating the pattern material 200a, IR (infrared ray) or UV (ultraviolet ray) drying process may be carried out so as to make the coated pattern material 200a be a gel state. Also, a cooling process may be carried out after the IR or UV drying process, to thereby restore the substrate 100 expanded during the drying process.

Then, as shown in FIG. 6c, edges of the coated pattern material 200a are cured.

Generally, the pattern material 200a is coated in a quadrangle shape on the active area of the substrate 100. Thus, four edges of the quadrangle-shaped pattern material 200a are cured.

The reason why the edges of the pattern material 200a are cured before the process of forming the pattern in the pattern material 200a (See the following process of FIG. 6d) is to prevent the shape of pattern material 200a from being deformed when a mold is brought into contact with the pattern material 200a for the process of forming the pattern.

Thus, the edge of the pattern material 200a to be cured has such a width as to prevent the deformation of pattern material 200a even though the mold is brought into contact with the pattern material 200a for the process of forming the pattern.

The process of curing the edges of the pattern material 200a may be carried out by a UV irradiation apparatus.

Then, as shown in FIG. 6d, the predetermined mold 500 is brought into contact with the pattern material 200a, to thereby form the pattern in the pattern material 200a.

The mold 500 is formed in consideration to the shape of pattern layer needed to be obtained. For example, a cross section of the mold 500 may be variously changed into a triangle, circle, or ellipse; and a pattern with the cross section may be variously changed into a stripe pattern, matrix pattern, or dot pattern.

As shown in FIG. 6e, the pattern material 200a with the pattern is cured.

The process of curing the pattern material 200a may be carried out through the use of UV irradiation apparatus.

As shown in the drawings, the process of curing the pattern material 200a is carried out under the circumstances the mold 500 is brought into contact with the pattern material 200a. Especially, in order to cure the pattern material 200a by UV irradiation over the mold 500, the mold 500 is formed of a transparent material.

As shown in FIG. 6f, the mold 500 is separated, to thereby complete the light guide plate of FIGS. 3a and 3b, which is provided with the pattern layer 200 on the active area of the substrate 100.

In the above process of FIG. 6b, the bead structures of the oxide such as SnO₂, TiO₂, ZnO₂, SiO₂ or CeO₂ are included in the pattern material 200a, and then the pattern material 200a is coated, to thereby obtain the light guide plate of FIG. 4.

When the above process is applied to both surfaces of the substrate 100, it is possible to obtain the light guide plate of FIG. 5.

The processes of FIGS. 6d to 6f among the aforementioned processes may be consecutively carried out in an apparatus without pause, which will be explained as follows.

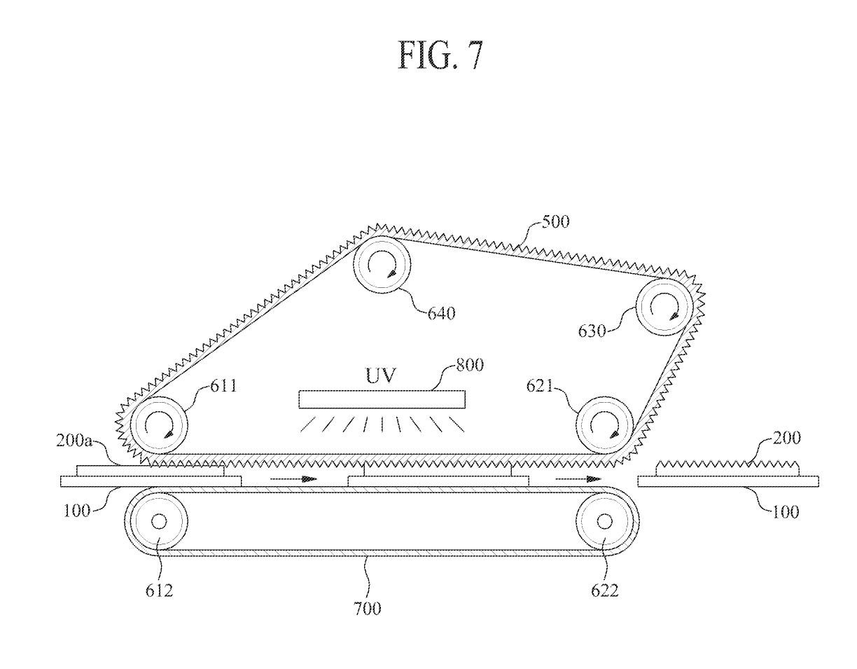

FIG. 7 is a rough view of an apparatus of manufacturing the light guide plate according to one embodiment of the present invention. This apparatus may perform the consecutive processes of forming the pattern in the pattern material through the use of mold (process of FIG. 6d), curing the pattern material with the pattern (process of FIG. 6e), and separating the mold (process of FIG. 6f).

As shown in FIG. 7, the apparatus of manufacturing the light guide plate according to one embodiment of the present invention includes a pair of first rolls 611 and 612, a pair of second rolls 621 and 622, a third roll 630, a fourth roll 640, a mold 500, a belt 700, and a UV irradiation apparatus 800.

The pair of first rolls 611 and 612 comprises the first upper roll 611 and first lower roll 612. The substrate 100 coated with the pattern material 200a is introduced into a space between the first upper roll 611 and the first lower roll 612.

The pair of second rolls 621 and 622 comprises the second upper roll 621 and second lower roll 622. The light guide plate with the pattern layer 200 on the substrate 100 is taken out of a space between the second upper roll 621 and the second lower roll 622.

The third roll 630 is positioned in the rear upper side of the second upper roll 621, wherein the third roll 630 separates mold 500 from the pattern material 200a.

The fourth roll 640 is positioned in the upper side between the first and second upper rolls 611 and 621, wherein the fourth roll 640 makes it possible to maintain a tension of the mold 500.

The mold 500 is rotated while being wound among the first upper roll 611, second upper roll 621, third roll 630, and fourth roll 640, whereby the mold 500 is brought into contact with the pattern material 200a coated on the substrate 100, thereby forming the pattern layer 200.

The belt 700 is wound on the first lower roll 612 and second lower roll 622, whereby the substrate 100 is moved through the use of belt 700. It is possible to provide an additional roll for winding the belt 700 on the first lower roll 612 and second lower roll 622.

The UV irradiation apparatus 800 is positioned between the first upper roll 611 and second upper roll 621, to thereby cure the pattern material 200a with the pattern on the substrate 100 being moved.

An operation of the apparatus shown in FIG. 7 will be explained as follows.

First, the substrate 100 coated with the pattern material 200a is introduced into the space between the pair of first rolls, that is, first upper roll 611 and first lower roll 612. Then, the mold 500 rotated while being wound among the first upper roll 611, second upper roll 621, third roll 630 and fourth roll 640 is brought into contact with the pattern material 200a, thereby forming the pattern in the pattern material 200a.

Under the circumstances the mold 500 is brought into contact with the pattern material 200a, the substrate 100 is moved toward the pair of second rolls 621 and 622. The substrate 100 is moved by rotation of the belt 700.

During movement of the substrate 100, the pattern material 200a is cured by the UV irradiation apparatus 800.

Then, after curing the pattern material 200a, the substrate 100 is taken out of the space between the pair of second rolls 621 and 622, that is, second upper roll 621 and the second lower roll 622. While the substrate 100 is taken out of the space, the mold 500 being brought into contact with the pattern material 200a is wound on the third roll 630, simultaneously. Naturally, the contact between the mold 500 and the pattern material 200a is released so that the mold 500 is separated from the substrate 200.

Meanwhile, the above apparatus of manufacturing the light guide plate according to the present invention covers the modifications and variations of this invention provided they come within the scope of the appended claims and their equivalents. For example, a roll with the mold 500 wound thereon may be additionally provided, and a roll for moving the substrate 100 may be additionally provided. Also, the apparatus of manufacturing the light guide plate according to the present invention may be simplified in structure by omitting at least one of the third roll 630 and fourth roll 640.

FIG. 7 illustrates the apparatus of consecutively carrying out the processes of FIGS. 6d to 6f. The apparatus of carrying out the processes of FIGS. 6a to 6c is arranged in-line before the apparatus of FIG. 7, to thereby consecutively carry out the entire processes for manufacturing the light guide plate according to the present invention.

What is claimed is:

1. A light guide plate comprising:
a transparent substrate including active and dummy areas, wherein the dummy area is positioned in the circumference of the active area, and the dummy area is provided with a plurality of grooves to be combined with other members; and
a pattern layer on one surface of the substrate, wherein the pattern layer is formed in the active area of the substrate, and is not formed in the dummy area of the substrate.

2. The light guide plate according to claim 1, wherein the substrate and pattern layer are formed of poly methyl methacrylate (PMMA), and an adhesive is not provided between the substrate and pattern layer.

3. The light guide plate according to claim 1, wherein bead structure are additionally included in the pattern layer.

4. The light guide plate according to claim 1, wherein a pattern layer is additionally formed on the other surface of the substrate, and the pattern layer on the other surface of the substrate is not formed in the dummy area, and is formed in the active area.

5. A method of manufacturing a light guide plate with a pattern layer on an active area of a substrate comprising:
preparing the substrate with a plurality of grooves in a dummy area in the circumference of the active area;
coating the active area of the substrate with a pattern material by a spinless coating method;
curing edges of the pattern material coated;
forming a pattern in the pattern material by bring a predetermined mold into contact with the pattern material;
curing the pattern material while being brought into contact with the mold; and
separating the mold.

6. The method according to claim 5, further comprising carrying out IR (infrared ray) or UV (ultraviolet ray) drying process and cooling process after coating the pattern material.

7. The method according to claim 5, wherein the process of coating the pattern material comprises coating the pattern material including bead structures therein.

8. The method according to claim 5, wherein the processes of forming the pattern in the pattern material, curing the pattern material, and separating the mold are consecutively carried out by an apparatus including a pair of first rolls consisting of a first upper roll and a first lower roll, a pair of second rolls consisting of a second upper roll and a second lower roll, a mold wound on the first upper roll and the second upper roll, and a UV irradiation apparatus positioned between the first upper roll and the second upper roll.

9. An apparatus of manufacturing a light guide plate comprising:
a pair of first roll consisting of a first upper roll and a first lower roll;
a pair of second roll consisting of a second upper roll and a second lower roll;
a third roll positioned in the rear upper side of the second upper roll;
a fourth roll positioned in the upper side between the first upper roll and the second upper roll;
a mold rotated while being wound among the first upper roll, the second upper roll, the third roll and the fourth roll; and
a UV irradiation apparatus positioned between the first upper roll and the second upper roll.
